(19) United States
(12) Patent Application Publication
(10) Pub. No.: US 2002/0024018 A1
(43) Pub. Date: Feb. 28, 2002

(54) Method of measuring phosphorescence or fluorescence

(76) Inventors: Michihiro Saito, Kashiwa (JP); Kazuo Yasuda, Hitachinaka (JP)

Correspondence Address: MATTINGLY, STANGER & MALUR, P.C., ATTORNEYS AT LAW, SUITE 370, 1800 DIAGONAL ROAD, ALEXANDRIA, VA, 22314, US

(21) Appl. No.: 09/930,146

(22) Filed: Aug. 16, 2001

(30) Foreign Application Priority Data
Aug. 24, 2000 (JP) 2000-254500

(51) Int. Cl. G01N 21/64

(52) U.S. Cl. 250/458.1; 250/459.1

(57) ABSTRACT

Regarding the method of analyzing and measuring a sample and a sample holder in a fluorescence measuring apparatus or phosphorescence measuring apparatus, the present invention is intended to eliminate or reduce the possibility of fluorescence and phosphorescence derived from the sample holder, and uses a holder material with little or no luminescence, fluorescence or phosphorescence for this object. The surface tension of sample liquid is effectively utilized to design the shape of the holder and to manufacture the holder.

A sample is placed on a sample holder when a sample is analyzed and measured in a fluorescence measuring apparatus or phosphorescence measuring apparatus. In this case, measurement is made independently of fluorescence or phosphorescence coming from other than said sample, without any object other than a sample placed in the path of excited light or light to be measured. The sample is held in said sample holder by surface tension. When a sample is measured in a fluorescence measuring apparatus or phosphorescence measuring apparatus, a carbon material, glassic carbon, tungsten carbon or pyro-coated carbon is processed and used to produce said sample holder. An inverted conical, triangular conical, cylindrical or prismatic hole is provided on the carbon material or material with the minimum fluorescence or phosphorescence caused by excited light, and a hole of a very small diameter is opened on the bottom. Said sample is held in the plate hole by surface tension without leakage of sample despite the presence of a hole on the bottom.

### BACKGROUND OF THE INVENTION

The present invention relates to a sample measurement method and sample holder in a fluorescence or phosphorescence measuring apparatus, and is characterized by elimination or reduction of fluorescence, phosphorescence and scattered light coming from the sample holder.

To hold a sample during measurement, the fluorescence measuring apparatus, phosphorescence measuring apparatus or measuring apparatus based on chemical luminescence method uses a cell or plate made of a transparent ore such as quartz and artificial stone thereof, or compound such as polycarbonate material and polyvinyl material.

Said cell or plate holds the sample firmly in position, and can be used and disposed of partly, and facilitates measurement. However, it is accompanied by luminescence, fluorescence and phosphorescence coming from these materials, and light other than the target light is detected together with the light emitted from the sample. These light beams coming from the sample holder are sometimes different in the intensity depending on the particular site, even if the same material is used. In the commercially available 96-hole micro plate, for example, the measured value of such light beams can be extremely high in several holes at the time of measurement even when a sample is not included. This shows that analysis and measurement are performed as if the sample would contain a measurement target although it does not contain any measurement target originally. This may lead to incorrect judgment. Further, although a cell or plate made of the same material is used, it leads, as a result, to a considerable reduction of the minimum detection limit in the analysis/measurement method or measuring instrument used since there are variations in the intensity of said light beams. Similarly, luminescence of this type occurs even when the same cell or plate is used repeatedly, and this also leads, as a result, to a considerable reduction of the minimum detection limit in the analysis/measurement method or measuring instrument used. In order to reduce the light coming from this sample holder or container, fluorescence analysis has been made in advance, the material with smaller light has been selected for the holder, a thinner material has been used or the surface of the material has been coated. Thus, in material development, fluorescence has been analyzed in advance, and a compound product or chemical substance with smaller fluorescence or natural stone has been selected, used and improved. However, any method has failed to reduce sufficiently or to eliminate completely the light coming from the sample holder and holder material.

It has been impossible to avoid the light coming from the sample holder and holder material. In order to avoid measurement of the interfering light coming from the sample holder material, a method of measuring fluorescence on a side surface or a method of measuring fluorescence on an illuminated surface is used. To take out a greater amount of excited light or fluorescence, a greater solid angle of luminous flux must be secured. However, this will make it difficult to manufacture a light measuring apparatus. Furthermore, when a method of measuring luminescence on an illuminated surface is used, a holder material is located on a very short extension line connecting between an excited light emitting lamp and a sample. Light coming from the sample holder and holder material may make it considerably different to analyze the sample. In a fluorescence measuring apparatus, phosphorescence measuring apparatus and luminescence measuring apparatus based on chemical luminescence method as well as an automatic analyzer using them, the light coming from the sample holder and holder material hinders analysis and measurement of a sample if it contains a trace quantity of target to be measured. Deterioration of the minimum detection limit of the apparatus due to the light coming from the sample holder and holder material reduces the capacity of the apparatus, and hinders analysis and detection of a small amount of critical substances contained in the sample.

The prior arts described above is based on the method of studying the sample holder material and using the material characterized by a smaller amount of light coming from said holder and holder material. Such materials are used independently or in combination, and the holder is formed so that there is no process of increasing the non-specific light of fluorescence or phosphorescence or luminescence coming from material in the step of machining and a substance emitting non-specific light is not mixed. Further, the surface is processed. For example, without using the holding material on top with the holder placed in the horizontal direction as in the case of a 96-hole microplate, the sample is held only on the bottom and side. For irradiation of excited light from the top or measurement of light from the top or bottom, the light is made to pass by only one surface of the material, according to the prior art. Further, a method of measuring luminescence on an illuminated surface is adopted for measurement of fluorescence or phosphorescence of the sample liquid, instead of a method of measuring luminescence on a transparent surface or a method of measuring fluorescence on a side surface, in order to ensure that light to measured does not pass by the holder material surface.

In any of these prior art methods, the sample holder is made of the material emitting non-specific light. The holder material is located in the path of excited light or fluorescence, phosphorescence, luminescence coming from the sample. The prior art is not sufficiently capable of removing the light coming from the sample holder and holder material.

The object of the present invention is to provide a sample holder which uses the surface tension of the sample liquid and permits analysis and measurement without a holder material placed in the path of the excited light or luminescence of sample. The present invention is intended to ensure the excellent minimum detection limit of the target for measurement in the sample, thereby allowing high-sensitivity analysis and measurement.

Another object of the present invention is to provide a sample holder using the carbon material and other materials without any light coming from the material or with very little light coming therefrom, thereby ensuring high-sensitivity analysis and measurement.

### SUMMARY OF THE INVENTION

When a sample is analyzed and measured using a fluorescence measuring apparatus or phosphorescence measuring apparatus, said sample is placed on a sample holder. In this case, there is no object except for the sample in the path of the excited light or light to be measured. Fluorescence and phosphorescence are measured without being affected by the light coming from an object other than the sample and from the sample holder and holder material. The sample is held by a sample holder by surface tension. Excited light from a lamp is received, and luminescence including fluorescence and phosphorescence is detected and analyzed by a detector. This method makes it possible to create a sample holder where the material of the sample holder minimizes detection and measurement of the fluorescence or phosphorescence coming from other than the sample and interfering with the measurement due to emission from the lamp. The sample is analyzed and measured by the method of measuring luminescence on a transparent surface or method of measuring luminescence on an illuminated surface. However, neither the optical axis of excited light nor and optical axis of measurement light pass by the holder material surface. Even if the wall side of the sample holder is exposed to the excited light, the problem is found only in interference by scattered light if the holder material is non-fluorescent and non-phosphorescent. This problem can be eliminated by analysis and measurement of time.

When the sample is measured by a fluorescence measuring apparatus or phosphorescence measuring apparatus, the carbon material is machined and used as a sample holder. An inverted pyramidal form including inverted cone, inverted triangular pyramid or inverted quadrangular pyramid, or a cylindrical or prismatic hole is opened from the top on the material with the minimum fluorescence or phosphorescence due to the carbon material or excited light. A hole of a very small diameter is opened on the bottom. Although there is a hole on the bottom, the sample does not leak. The sample is maintained within the plate hole by surface tension.

### BRIEF DESCRIPTION OF DRAWINGS

FIGS. 1 to 4 are drawings representing a sample holder according to the present invention;

FIG. 5 is a drawing representing the fluorescence and phosphorescence measuring method according to the present invention; and

FIGS. 6 to 10 are drawings representing a measurement apparatus according to the present invention.

### DETAILED DESCRIPTION OF THE PREFERRED EMBODIMENT

The following describes the embodiments of a sample holder according to the present invention with reference to drawings:

### EXAMPLE 1

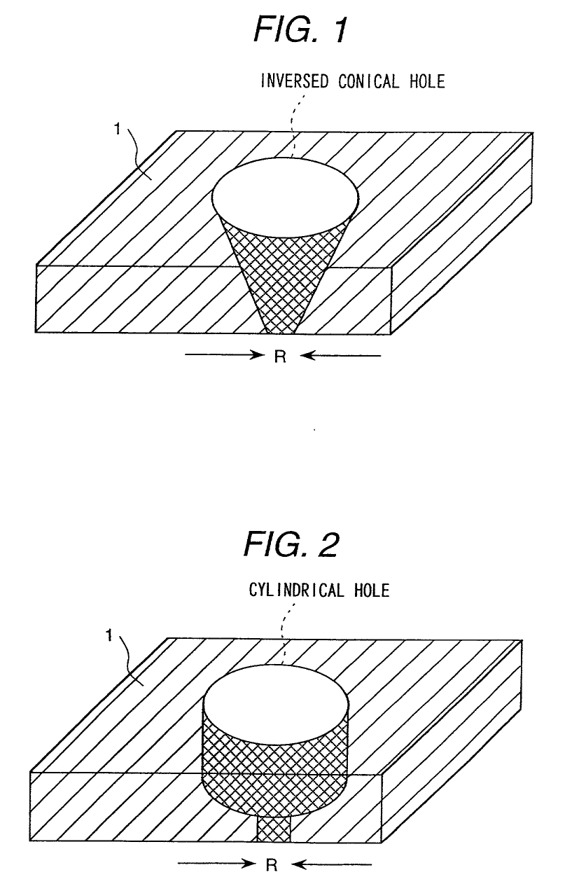

The following describes an example of a holder used in the fluorescence measuring apparatus on which a common sample holder is mounted: As shown in FIG. 1, an inverted cone is opened from the top of a carbon material, and an very tiny hole is opened on the bottom. The proper diameter of the bottom hole is 0.005 to 3 mm. 0.05 to 200 microliters of a sample is dripped in the depression of this cone, and analysis and measurement is made by a measuring instrument. The carbon material is impermeable to liquid, and the material made of glassic carbon or tungsten carbon is used, or a pyro-coated material is preferred. The material having a greater diameter of the bottom hole is preferred. It is preferred that a greater number of samples be held. The amount of the sample to be held by surface tension differs according to the viscosity of the sample, the presence or absence of particulates, clump or surfactant in the sample, or the presence or absence and concentration of surfactant.

In this case, a method of measuring luminescence on a transparent surface or a method of measuring luminescence on an illuminated surface is used for measurement.

It is also possible to open an inverted triangular or quadrangular pyramid. The area of the bottom hole is preferred to be 0.0001 to 5 square millimeters. A thinner bottom carbon material is more preferred, but must not be fragile. The preferred range of thickness is from 0.003 to 2 mm. The diameter of a circle on the top of the inverted conical shape or the area of a triangle or square depends on the size of the bottom hole. It is preferred to be from 0.01 to 10 or from 0.01 to 100 square millimeters. The height of the sample base is preferred to be from 0.02 to 15 millimeters.

### EXAMPLE 2

As shown in FIG. 2, a hole is opened on the carbon material. A large-diameter cylinder is opened on the top, while a small-diameter cylinder is opened on the bottom so that a great deal of samples can be held. The appropriate diameter will be from 0.005 to 3 millimeters. 0.05 to 200 microliters of sample is dripped into the depression of the cylindrical form to perform analysis and measurement. A method of measuring luminescence on a transparent surface is used for measurement in this case.

It is also possible to open a triangular or square hole. The area of the bottom hole is preferred to be 0.0001 to 5 square millimeters. A thinner bottom carbon material is more preferred, but must not be fragile. The preferred range of thickness is from 0.003 to 2 mm. The diameter of a circle on the top of the column or triangular or square area depends on the size of the bottom hole. It is preferred to be from 0.01 to 10 or from 0.01 to 100 square millimeters. The height of the sample base is preferred to be from 0.02 to 15 millimeters.

### EXAMPLE 3

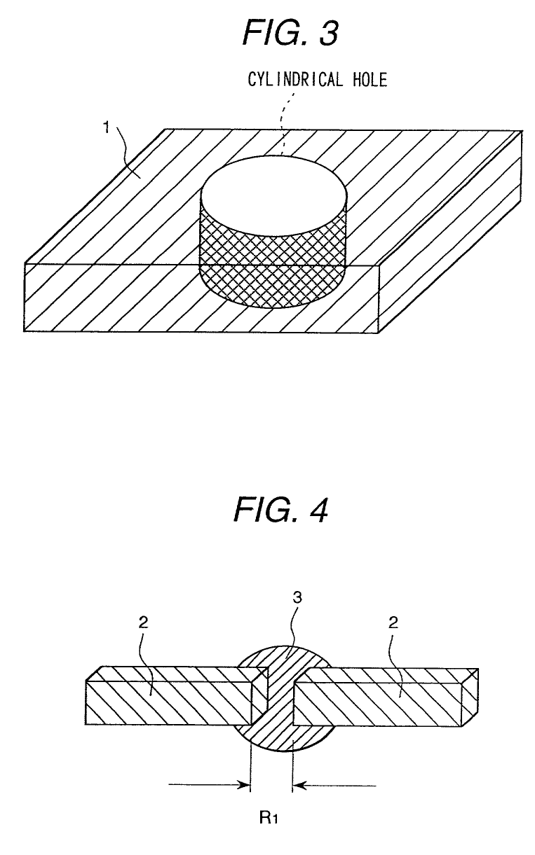

As shown in FIG. 3, a depression of conical or cylindrical form is provided on the top of the carbon material. Or prepare a depression of quadrangular prism, inverted quadrangular pyramid, prism, or inverted pyramid. This depression does not reach the bottom to open the hole. This depression can be of any size. A commercially available 96-hole microplate has a circular top of about 6.5 mm in diameter. The carbon material on the bottom is preferred to be thinner, but must not be fragile. The preferred thickness is from 0.03 to 2 mm. A method of measuring luminescence on an illuminated surface can be used for measurement in this case.

### EXAMPLE 4

As shown in FIG. 4, two circular tubes or square tubes of carbon material are manufactured, and are held at a small space in the lateral or vertical direction. The appropriate space will be from about 0.005 to 4 mm. A small amount of a sample liquid of about 0.02 microliter to 200 microliter is dripped into this space with these rods as the base and the resulting luminescence is measured and analyzed by a measuring apparatus. The size of each rod in the specimen areacan be any but preferably be 0.005 square mm to 100 square mm.

### EXAMPLE 5

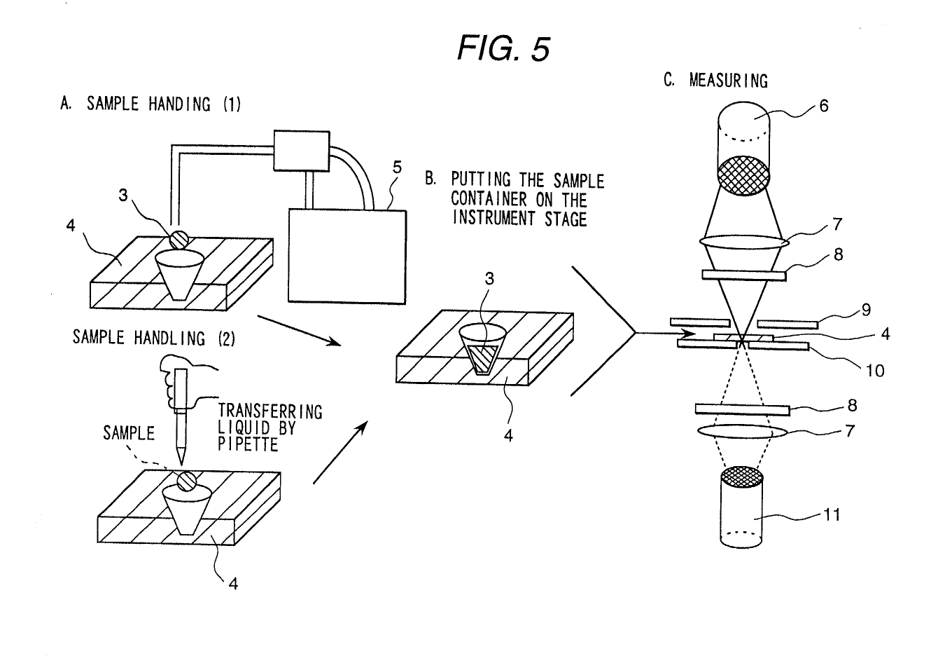

As shown in FIG. 5, an automatic liquid handler (given in “A. Sample handling (1)” of FIG. 5) or a pipette (given in “A. Sample handling (2)” of FIG. 5) is used artificially to pipette the sample into the sample holder hole. The amount of the sample can be from about 0.02 to 200 microliters. It is not preferred to allow it to leak around the hole. Although the lower portion of the holder has a hole having a diameter of 0.0001 to 5 square millimeter, the sample is held in the holder by surface tension (given in “B. Putting the sample container on the instrument stage” of FIG. 5). If the amount of sample is small, uneven distribution in the hole may result in a big fluctuation at the time of measurement. So a slight vibration is give to ensure uniform distribution of the sample. If there is a great amount of sample, the sample surface may be uneven due to the surface tension of the sample. So after pipetting into the sample holder, a slight vibration is given in the similar way to get a smooth surface. To prevent the holder from being contaminated and unwanted interfering light or scattered light from occurring, it is preferred that the holder can be held and transferred without the top or bottom surface exposed to the light being touched by hand.

The center of the bottom hole of the sample holder is preferred to be located at the center of light. Preferably, the holder base is provided with a guide to ensure that the sample is held at a specified position (given in “B. Putting the sample container on the instrument stage” of FIG. 5). When the holder is located at a deviated position, measurement may be insufficient. The sample holder is placed on the light measuring instrument holder base. The sample holder in the apparatus is set to the position of the measuring unit exposed to the light, and measurement is carried out (given in C. Measurement in FIG. 5).

### EXAMPLE 6

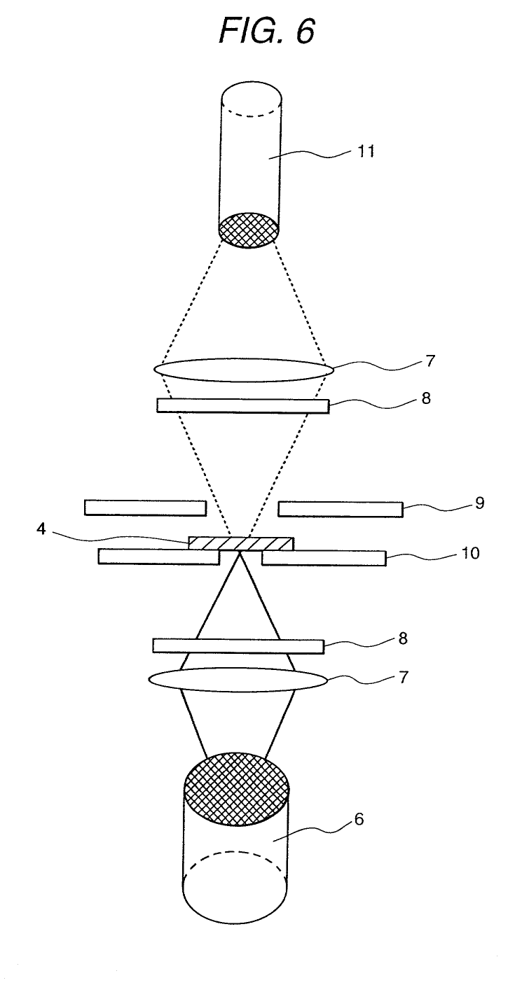

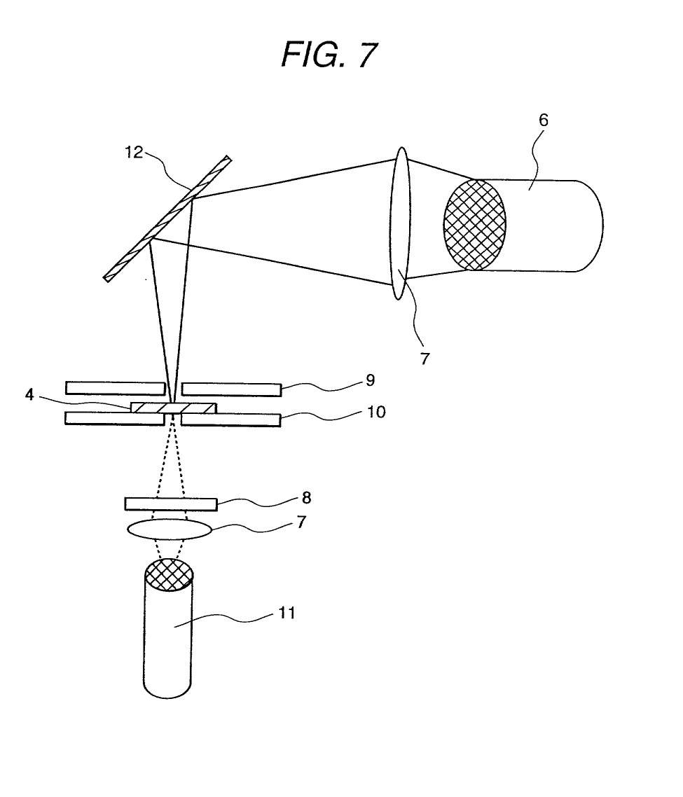

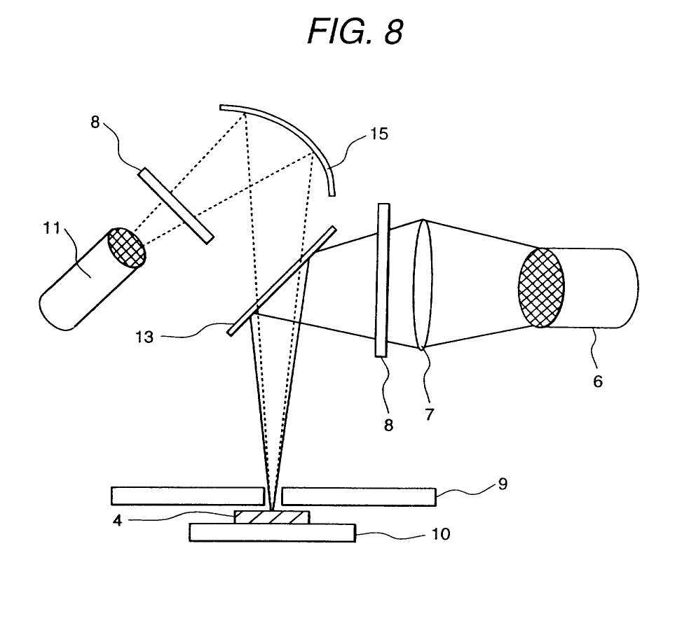

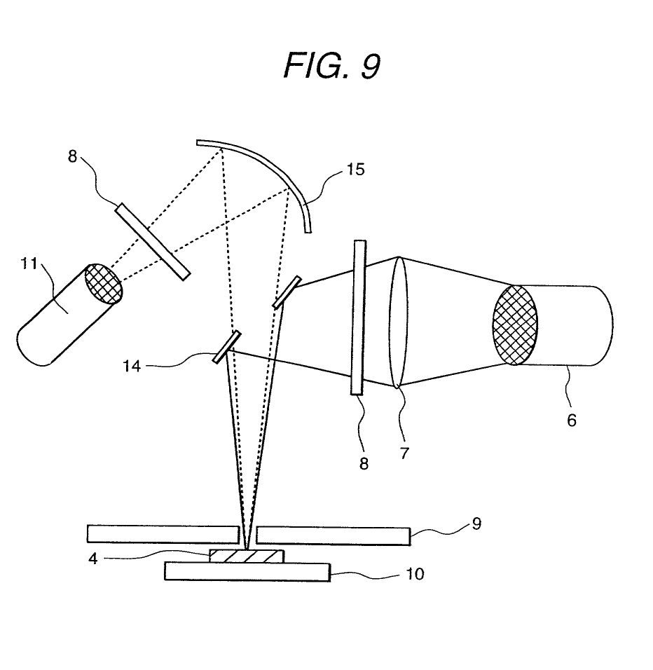

FIGS. 6 to 9 show the arrangement of the optical system using this sample holder. The apparatus can perform measurement according to the method of measuring luminescence on a transparent surface (from FIGS. 6 to 7), method of measuring luminescence on an illuminated surface (FIGS. 8 and 9). The sample holder is set on the sample stage in any of these methods. Excited light emitted from the light source is condensed by a lens. The light passes through a colored glass filter, and the wavelength is selected. Then the sample is exposed to the light. A Xenon lamp, tungsten lamp or laser is used as a light source. The solid angle of the excited light in this case and the distance from the light source and lens to the sample are preferred to be fitted to the size of the sample and sample holder. Direct irradiation of the light applied to the sample holder sample may give rise to scattered light or excess light coming from the sample holder and holder material. So the excited light applied to the sample as parallel light is preferred to be have a size equivalent to or smaller than the illuminated area of the sample. Or when light comes into a focus in or around the sample, it is preferred that the opening of the holder and luminous flux have the same size with each other or the size of the luminous flux is slightly smaller. When method of measuring luminescence on a transparent surface and the light is not parallel, the center of the bottom hole is preferred to be the focus of light in the sample holder shown in FIGS. 1 and 2. In this case, a light source is placed on the bottom and the measuring instrument on the top, as shown in FIG. 7, and light is applied from the bottom of the measuring instrument container holder, thereby measuring light. This is done with fluorescence and phosphorescence due to excited light occurring non-directionally, and more effective light measurement and detection may be made. In FIG. 3, method of measuring luminescence on an illuminated surface can be used. When the method of measuring luminescence on an illuminated surface is used, the bottom of the sample is preferred to be a focus in the sample holder of FIGS. 1, 2 and 3. If carbon material is used also on the side of the sample holder in this case, both excited light and luminescence does not cross the sample holder. To ensure more effective irradiation and light condensation, a dichroic filter, split mirror, translucent mirror, plane mirror, concave mirror or optical fiber may be used.

In fluorescence/phosphorescence measuring technique, the wavelength of fluorescence or phosphorescence is generally different from that of the excited light. To ensure that the excited light is suited to the sample and does not have the wavelength equal to or adjacent to that of the fluorescence or phosphorescence or cut off the scattered light, colored glass filter and interference filter may be used independently or in combination. Such a filter or mirror emits fluorescence through ultraviolet ray. Light may be scattered to enter the measurement and may be detected in some cases. If a problem arises from such light, the interference filter and colored glass filter characterized by little radiation of fluorescence are elected. At the same time, their combination is studied to ensure that fluorescence not coming from the sample is made sufficiently small. In the sample holder shown in FIGS. 1, 2 and 3, the method of measuring luminescence on a transparent surface or method of measuring luminescence on an illuminated surface is adopted if the holder side is made of carbon material; the method of measuring luminescence on a side surface is not adopted. Any of the method of measuring luminescence on a transparent surface, method of measuring luminescence on an illuminated surface and method of measuring luminescence on a side surface can be used in the sample holder shown in FIG. 4. The focus of transmitted light is provided at the center of the sample or around it or at the center of the split or around it so that an effective fluorescence and phosphorescence of the sample are assured and scattered light is minimized. It is preferred that refractive index of excited light in the sample be also taken into account. In any of these methods, it is required that a sufficiently effective measurement of fluorescence and phosphorescence coming from the sample be ensured, and measurement of fluorescence and phosphorescence not coming from the sample such as the light source, lens or sample holder be sufficiently minimized. If laser beam is used as a light source, the size of the luminous flux or the center of the applied light should meet the objective of measurement. This is easier to set than the lamp.

The intensity of the fluorescence or phosphorescence emitted from the sample is measured by a photometer. A photoelectron multiplier, CCD camera, photo diode or the like is used as photometer. A lens or mirror is used for an effective concentration of fluorescence or phosphorescence issued from the sample. In the fluorescence or phosphorescence measurement technique, the wavelength of the fluorescence or phosphorescence is generally different from that of the excited light.

So a colored glass filter and interference filter may be used in some cases independently or in combination where excited light or scattered light is cut off and fluorescence or phosphorescence is allowed to pass by.

Measurements obtained from the photometer are displayed on the screen attached to the photometer, printed out or loaded into the connected computer.

FIGS. 6 and 7 show the schematic diagram of a method of measuring luminescence on a transparent surface. In FIG. 7, a light source is installed on the bottom to emit excited light. In FIG. 8, a reflecting mirror is installed in the path of excited light to reflect the excited light. Similarly, a mirror can be placed on the side of the photometer to reflect fluorescence or phosphorescence. FIGS. 8 and 9 are the schematic diagrams of the method of measuring luminescence on an illuminated surface. In FIG. 8, a dichroic filter is placed to reflect the excited light, with fluorescence and phosphorescence allowed to pass by. A concave mirror is used to concentrate reflected fluorescence or phosphorescence onto the photometer. A plane mirror, lens or optical fiber may be used for this purpose. In order that the sample is exposed to excited light, a split mirror without mirror is installed in FIG. 9 at the position where fluorescence or phosphorescence passes by. Anything which may be exposed to excited light is not placed in the path of fluorescence or phosphorescence. This is intended to eliminate or minimize the possibility of entry into the photometer the light coming from the sample holder and holder material due to excited light or scattered light. The fluorescence or phosphorescence can be reflected by a mirror and excited light can be applied through the split of the mirror.

(1) The present invention avoids interference caused by the sample holder mateial in the measurement of light when a fluorescence measuring apparatus, phosphorescence measuring apparatus or chemical luminescence method is used.

(2) Interference in measurement of light coming from the sample holder and deteriorates detection limit.

The present invention allows the apparatus to be fully used to its capacities and ensures highly sensitive and effective detection of a trace quantity of substances present in the sample.

What is claimed is:

1. A measurement method for analysis and measurement of a sample in a fluorescence measuring apparatus or phosphorescence measuring apparatus,
wherein a sample is held by a sample holder through surface tension and only said sample is placed in the path of excited light;
said measurement method further characterized in that measurement is made without detecting light of fluorescence, phosphorescence coming from sample holder material or scattered light, wherein an intermediary of any sample holder material is not used.

2. A sample holder and measurement method using said sample holder for analysis and measurement of a sample in a fluorescence measuring apparatus or phosphorescence measuring apparatus,
wherein a sample is held by a sample holder through surface tension and only said sample is placed in the path of excited light;
said measurement method further characterized in that measurement is made without measuring light of fluorescence, phosphorescence coming from sample holder material or scattered light, wherein an intermediary of any sample holder material is not used.

3. A sample holder and measurement method using said sample holder for analysis and measurement of a sample in a fluorescence measuring apparatus or phosphorescence measuring apparatus, characterized in that
a hole with an inverted pyramidal form including as an inverted conical, inverted triangular or inverted quadrangular shape is formed on a carbon material, glassic carbon, tungsten carbon or pyro-coated carbon, or a material with very small fluorescence or phosphorescence caused by scattered light, and
there is no leakage of sample despite the presence of a hole with an area of 0.0001 to 5 square millimeter without material on the bottom;
wherein said sample is held in said sample holder by surface tension.

4. A sample holder and measurement method using said sample holder for analysis and measurement of a sample in a fluorescence measuring apparatus or phosphorescence measuring apparatus, characterized in that
a cylindrical, triangular prismatic or quadrangular prismatic hole is formed on a carbon material, glassic carbon, tungsten carbon or pyro-coated carbon, or a material with very small fluorescence or phosphorescence caused by scattered light, and
there is no leakage of sample despite the presence of a hole with an area of 0.0001 to 5 square millimeter without material on the bottom;
wherein said sample is held in said sample holder by surface tension.

5. A sample holder and measurement method using said sample holder for analysis and measurement of a sample in a fluorescence measuring apparatus or phosphorescence measuring apparatus, characterized in that
a carbon material, glassic carbon, tungsten carbon or pyro-coated carbon, or a material with very small fluorescence or phosphorescence caused by scattered light is shaped in prismatic forms on said sample holder which are held at intervals of 0.2 mm to 3 mm in the lateral or vertical direction,
wherein there is no leakage of sample despite the presence of a gap without material and said sample is held between prismatic forms by surface tension.

6. A method of measuring phosphorescence or fluorescence on a transmission surface, wherein said method uses a sample holder built up to hold sample liquid by surface tension with columns made of carbon, glassic carbon, tungsten carbon or pyro-coated carbon, or materials which generate very little fluorescence or phosphorescence by excited light beams.

7. A sample holder and measurement method using said sample holder for analysis and measurement of a sample in a fluorescence measuring apparatus or phosphorescence measuring apparatus, characterized in that,
when light is measured according to the method of measuring fluorescence on a transparent surface or method of measuring phosphorescence on a transparent surface,
only a sample is placed in the path to reduce or eliminate the possibility of detecting and measuring non-specific fluorescence or phosphorescence which would be derived from other than the sample.
